(19) United States
(12) Patent Application Publication
(10) Pub. No.: US 2010/0235272 A1
(43) Pub. Date: Sep. 16, 2010

(54) ROSCA-RISK MANAGEMENT SYSTEM AND METHOD THEREOF

(76) Inventor: Yung-Sung CHIEN, Taipei (TW)

Correspondence Address: Muncy, Geissler, Olds & Lowe, PLLC, 4000 Legato Road, Suite 310, FAIRFAX, VA, 22033, US

(21) Appl. No.: 12/720,290

(22) Filed: Mar. 9, 2010

(30) Foreign Application Priority Data
Mar. 11, 2009 (TW) 098107790

(51) Int. Cl. G06Q 40/00

(52) U.S. Cl. 705/37

(57) ABSTRACT

The present invention provides a Rosca-risk management system and a method thereof. The Rosca-risk management method conducts risk management on a Rosca group by using a processing apparatus. The processing apparatus is connected with a client through a network. The processing apparatus executes the following steps: determining a risk management term No. of the Rosca group according to a Rosca condition and a risk tolerance level of the Rosca group; determining, via the client, that a current bidding term No. of a member is not earlier than the risk management term No.; and allowing the member to enter into a bidding procedure of the Rosca group via the client.

This application claims priority to Taiwan Patent Application No. 098107790 filed on Mar. 11, 2009.

### CROSS-REFERENCES TO RELATED APPLICATIONS

Not applicable.

### BACKGROUND OF THE INVENTION

1. Field of the Invention

The present invention relates to a Rosca(Rotating Savings & Credit Association)-risk management system that is implemented through a network.

2. Descriptions of the Related Art

Since the advent of the Internet, the financial industry has needed a banking system in network form, referred by some people as “Future Bank”. However, until now, the application of network technologies in the financial industry is still limited to the electronization of the internal operations of conventional banks to improve only the general operational efficiency of the banks, with the overall architecture still operating on the basis of a close-minded concept. Therefore, there is still a long way before an efficient network-finance can truly be accomplished; for this reason, open direct network-finance operation systems have become development targets of modern banks.

The existing operation mode of modern banks still relies on advance credit investigations as a primary measure to manage credit risks. This practice completely relies on credit ratings (joint credit investigations) and collaterals as a measure to evaluate customer credit risks. In time periods when financial situations are stable, this operation mode may exclude customers due to an imperfect credit rating system or failure of the customer to provide collaterals; and in the case of financial turbulences, this operation mode may cause consecutive financial disasters due to lack of a risk assessment system, which can be best demonstrated by the Financial Tsunami that has happened in recent years.

To get out of troubles currently confronted by the financial industry, two websites that are engaged in direct network-finance, ZOPA and Prosper, appeared in the U.K and U.S. respectively in 2006. These direct network-finance websites provide platforms for debtors and creditors to conduct direct financing through a network to decrease dependency of the customers on indirect finance and improve the capital transaction efficiency. Although these websites may be considered as a rudimentary form of direct network-finance, they fail to provide guarantee against customer defaults, and still completely rely on credit rating systems to screen customers. Consequently, such websites are not implemented on a large scale in the market, and thus, not contributing to the improvement of the overall financial market efficiency.

In 2008, Bank Sinopac created the MMA Bidmoney network, which is an innovative direct network-finance solution based on the so-called Rosca (Rotating Savings & Credit Association). Because Rosca incorporates depositing and loaning together, the MMA Bidmoney network delivers higher direct finance efficiency than the two websites ZOPA and Prosper. However, for the public, it is still highly desirable to efficiently utilize the unique features of the mechanism of the MMA Bidmoney network to provide a more effective risk management solution that can promote the participation of customers. In view of this, the present inventor devises a “Rosca-risk management system” of the present application, which will be briefly described hereinbelow.

### SUMMARY OF THE INVENTION

To solve the aforesaid problems, an objective of the present invention is to provide a method for the risk management of a Rosca group by using a processing apparatus. The processing apparatus is connected with a client through a network. The method comprises the following steps: (A) enabling the processing apparatus to determine a risk management term No. of the Rosca group according to a Rosca condition and a risk tolerance level of the Rosca group, wherein the Rosca condition comprises at least one of the following components: a Rosca group term No., a basic contribution amount, an Rosca period and a total contribution scale; (B) enabling the processing apparatus to determine whether a current bidding term No. of a member is earlier than the risk management term No. via the client; and (C) enabling the processing apparatus to, according to the determination result of step (B), determine whether the current bidding term No. is earlier than the risk management term No. and then if not, allow the member to enter into a bidding procedure of the Rosca group via the client; or if so, then after determining that the member has passed a bidding qualification credit investigation procedure, allow the member to enter into the bidding procedure of the Rosca group via the client.

Another objective of the present invention is to provide an Rosca-risk management system. The Rosca-risk management system comprises a storage module, a receiving module, a risk management module and a processing module. The storage module is configured to store a Rosca group which records a Rosca condition and a risk tolerance level, wherein the Rosca condition comprises at least one of the following components: a Rosca group term No., a basic contribution amount, a Rosca period and a total contribution scale. The receiving module is connected to a client through a network and configured to receive a current bidding term No. of a member from the client. The risk management module is configured to determine a risk management term No. of the Rosca group according to the Rosca condition and the risk tolerance level of the Rosca group, and determine whether the current bidding term No. of the member is earlier than the risk management term No. The processing module is configured to do the following: if, according to the determination result of the risk management module the current bidding term No. is not earlier than the risk management term No., then the processing module will allow the member to enter into a bidding procedure of the Rosca group via the client; if the current bidding term No. is earlier than the risk management term No., then after determining that the member has passed a bidding qualification credit investigation procedure, allow the member to enter into the bidding procedure of the Rosca group via the client.

Yet another objective of the present invention is to provide a method for the risk management of a Rosca group by using a processing apparatus. The processing apparatus is connected with a client through a network. The method comprises the following steps: (A) enabling the processing apparatus to determine a risk management term No. of the Rosca group according to a Rosca condition and a risk tolerance level of the Rosca group, wherein the Rosca condition comprises at least one of the following components: a Rosca group term No., a basic contribution amount, an Rosca period and a total contribution scale; (B) enabling the processing apparatus to determine whether an intended bidding term No. of a member is earlier than the risk management term No.; and (C) enabling the processing apparatus to, according to the determination result of the step (B), determine whether the intended bidding term No. is earlier than the risk management term No., and then if so, according to a first credit limit of the member, determine that the first credit limit is not less than a contribution amount required for the intended bidding term No. and place the member into the Rosca group according to the intended bidding term No. of the member; or if the intended bidding term No. of the member is not earlier than the risk management term No., then place the member into the Rosca group according to the intended bidding term No. of the member, wherein the first credit limit is determined according to at least one of the following criteria: an employment status, income, a credit status, assets and collateral information of the member.

Yet a further objective of the present invention is to provide a Rosca-risk management system, which comprises a storage module, a receiving module, a risk management module and a processing module. The storage module is configured to store a Rosca group which records a Rosca condition and a risk tolerance level, wherein the Rosca condition comprises at least one of the following components: a Rosca group term No., a basic contribution amount, an Rosca period and a total contribution scale. The receiving module is connected with a client through a network and configured to receive an intended bidding term No. from a member via the client. The risk management module is configured to determine a risk management term No. according to the Rosca condition and the risk tolerance level of the Rosca group, and determine whether the intended bidding term No. of the member is earlier than the risk management term No. The processing module is configured to do the following: if, according to the determination result of the risk management module the intended bidding term No. of the member is earlier than the risk management term No., then according to a first credit limit of the member, if the first credit limit is not less than a contribution amount required for the intended bidding term No., the member is placed into the Rosca group according to the intended bidding term No. of the member; if the intended bidding term No. of the member is not earlier than the risk management term No., then the member is placed into the Rosca group according to the intended bidding term No. of the member. The first credit limit is determined according to at least one of the following criteria: an employment status, income, a credit status, assets and collateral information of the member.

The present invention determines whether the client has to be subjected to a credit investigation beforehand according to the intended bidding term No. of the client, and conducts the primary credit investigation operation when the client later desires to actually bid. This is advantageous in that those who only desire to earn interests by depositing money can join the Rosca group at a lower credit level; furthermore, it is possible to place clients with different intended bidding term Nos. into a same Rosca group, thereby making use of the whole capital of the Rosca group more efficient.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a network Rosca system of the present invention;

FIG. 2A is a flowchart of a network Rosca method of the present invention; and

FIG. 2B is another flowchart of the network Rosca method of the present invention.

### DESCRIPTION OF THE PREFERRED EMBODIMENT

For better understanding of the present invention, the present invention will be described in detail with reference to preferred embodiments thereof.

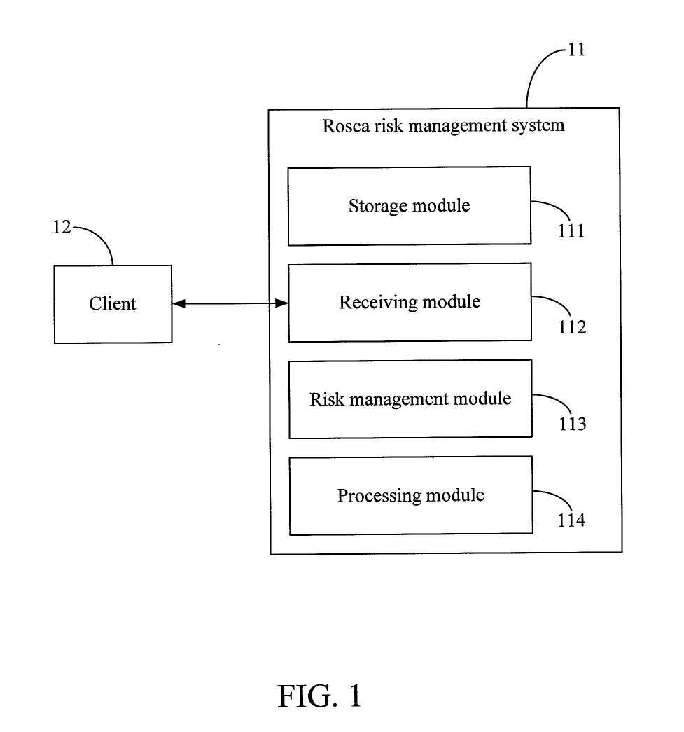

The first embodiment of the present invention is a Rosca-risk management system 11, a schematic view of which is shown in FIG. 1. The Rosca-risk management system 11 comprises a storage module 111, a receiving module 112, a risk management module 113 and a processing module 114. The storage module 111 is configured to store an Rosca group, which records a Rosca condition and a risk tolerance level. The Rosca condition is configured to distinguish between different groups of Rosca. Because different conditions may result in different groups of Rosca, the Rosca condition comprises at least one of the following components: a Rosca group term No., a basic contribution amount, an Rosca period and a total contribution scale to clearly distinguish between various Rosca groups of different conditions. The risk tolerance level is a market capital interest level. Furthermore, by using a client 12, a member can be connected with the receiving module 112 of the Rosca-risk management system 11 through a network to make a bid. The risk management module 113 is configured to determine a risk management term No. of the Rosca group according to the Rosca condition and the risk tolerance level of the Rosca group.

First, the receiving module 112 of the Rosca-risk management module 11 receives an intended bidding term No. of the member from the client 12. Then, by comparing the intended bidding term No. of the member with the risk management term No., the risk management module 113 determines whether to allow the member to join a Rosca group that the member wants to join without performing a credit investigation step. If the intended bidding term No. of the member is set to be later than the risk management term No., this means that this member prefers to earn interests by depositing money. For such a member, there is a lower risk of fraud, so the member may be join the Rosca group without performing the credit investigation step to prevent a cumbersome credit investigation procedure. More specifically, if the risk management module 113 determines that the intended bidding term No. of the member is not less than the risk management term No., it will place the member directly into the Rosca group so that the member can enter into a bidding procedure of the Rosca group to perform subsequent Rosca-related operations.

On the other hand, if the risk management module 113 determines that the intended bidding term No. of the member is less than the risk management term No., this means that there is a higher risk that the member might commit fraud. Hence, a credit investigation must be made beforehand on the member to obtain a first credit limit. The first credit limit may be determined according to at least one of the following criteria: an employment status, income, a credit status, assets and collateral information of the member to confirm that the member, who presents a higher risk to commit fraud, has qualifications adequate to bear a risk. Subsequently, the processing module 114 determines whether the first credit limit is larger than a contribution amount required for the intended bidding term No. to assess a risk that the member might commit a fraud. Here, the “contribution amount required for the intended bidding term No.” refers to the situation in which if the member bids in the intended bidding term, the contribution amounts that he paid in the preceding terms may also be used as a part of the credit.

In particular, if the first credit limit is less than the contribution amount, this means that there is a higher risk that the member might commit fraud, so the member may be requested to provide additional credit guarantee information. If the member fails to provide additional credit guarantee information, he will be denied membership in the Rosca group. Conversely, if the first credit limit is not less than the contribution amount, this means that there is a lower risk that the member might commit fraud, so the processing module 114 places the member into the Rosca group. For example, if the Rosca group that the member wants to join has a total group term No. of 37 and a periodic contribution amount of $10,000, and the risk management term No. is the 20^{th} term and the intended bidding term No. of the member is the 18^{th} term, then it can be assessed in advance that the member has paid (18−1)*$10,000=$170,000 before the 18^{th} term. Hence, the member has a virtual credit limit of $170,000 which, in addition to a credit guarantee limit of $200,000 arising from asset information additionally provided by the member, results in a first credit limit of $170,000+$200,000=$370,000. Then, it is determined that the first credit limit ($370,000) is not less than the total contribution scale (37*$10,000=$370,000), which means that there is a lower risk that the member might commit fraud. Therefore, the member will be placed into the Rosca group.

It shall be particularly noted that the processing module 114 may further place the member into an appropriate Rosca group according to the intended bidding term No. of the member. More specifically, if members with different intended bidding term Nos. are arranged into the same Rosca group, the members with the same intended bidding term No. that would bid in the same term can be preliminarily avoided, thereby allowing for optimized rotating use of the Rosca funds.

Once the placement of members in the Rosca group has been accomplished through the aforesaid steps, subsequent Rosca operations of the Rosca group are to commence. Initially, after a bidding application for a current bidding term is received by the receiving module 112 from the member, the risk management module 113 determines whether the current bidding term No. of the member is less than the risk management term No. If so, this means that there is a higher risk that the member might commit fraud, so a bidding qualification credit investigation procedure has to be carried out to determine whether the member has adequate qualifications to bid. If the member passes the bidding qualification credit investigation procedure successfully, he will be allowed to bid; conversely, if the member fails to pass the bidding qualification credit investigation procedure, he will be denied to bid in this term. On the other hand, if the current bidding term No. of the member is not less than the risk management term No., this means that there is a lower risk that the member might commit fraud, so he can be allowed to bid directly.

During the bidding process, the bidding amount claimed by the member for the current bidding term is received by the receiving module 112, and then the processing module 114 determines whether the member wins the bid according to the bidding amount. Once it is determined that the member wins the bid, it will be determined whether a total in-account limit of the member is greater than the total contribution scale to confirm whether the member can receive the whole contribution amount he wins. Here, the total in-account limit of the member is equal to a second credit limit of the member plus a system natural limit. Likewise, the second credit limit is determined according to at least one of the following criteria: an employment status, income, a credit status, assets and collateral information of the member. The system natural limit is equal to a creditor's right amount of the member minus a debt amount of the member. The creditor's-right amount refers to, among all Rosca groups that the member joins in a network Rosca organization to which the Rosca group belongs, an amount of creditor's rights of the member in all Rosca groups where he does not win a bid; in other words, the creditor's-right amount refers to a total contribution amount he has paid in all the Rosca groups he has joined. The debt amount refers to, among all Rosca groups that the member joins in the network Rosca organization, an amount to be paid by the member in all Rosca groups where he has won a bid; in other words, the debt amount refers to an amount to be paid in all Rosca groups that he has won a bid.

More specifically, if the processing module 114 determines that the member wins the bid in the current bidding term, it must make sure whether the credit limit of the member in the current bidding term is sufficient to allow the member to receive the whole contribution amount he has won. In other words, if, after the member has won the bid in the current bidding term, the processing module 114 determines that the total in-account limit of the member in the current bidding term is not less than the total contribution scale, this means that there is a very low risk that the member might commit fraud. Accordingly, a settlement-and-delivery procedure is then carried out by the processing module 114 to directly calculate an amount that the member has won in this term according to the bidding amount.

For example, if the Rosca group that the member joins has a total group term number of 37, the risk management term No. is the 20^{th} term and the member makes a bid at the bidding amount in the 14^{th} term, then the risk management module 113 determines that the current bidding term No. (the 14^{th} term) is less than the risk management term No. (the 20^{th} term). Then, because the member has paid the periodic contribution amount of $10,000 for 13 terms and the second credit investigation information of the member has a credit limit of $300,000, the total in-account limit of the member in the current bidding term is (14−1)×$10,000+$300,000=$430,000. Therefore, because the total in-account limit ($430,000) is greater than the total contribution scale ($370,000), a settlement-and-delivery procedure is carried out by the processing module 114 to calculate a winning amount of the member in this term according to the bidding amount.

Conversely, if, after the member has won the bid in the current bidding term, the processing module 114 determines that the total in-account limit of the member in the current bidding term is less than the total contribution scale, this means that there is a higher risk that the member might commit fraud, in which case it must be further determined how much of the winning amount the member can receive. Furthermore, because there is a higher risk that the member might commit fraud, the member may determine himself whether to provide additional credit information.

More specifically, after knowing that the total in-account limit in the current bidding term is less than the total contribution scale, the member determines himself whether to provide credit enhancement information. If the member does not provide any credit enhancement information, the processing module 114 will carry out a partial settlement procedure directly; otherwise, if the member provides the credit enhancement information to the receiving module 112 of the Rosca-risk management system 11, then the processing module 114 updates the total in-account limit into an enhanced total in-account limit according to the credit enhancement information. In particular, the processing module 114 may calculate an additional credit limit according to the credit enhancement information provided by the member, and then add the additional credit limit to the original total in-account limit to get an enhanced total in-account limit. Accordingly, the member will possess a higher credit limit to facilitate his acquisition of the winning amount.

Furthermore, after updating the total in-account limit of the member into the enhanced total in-account limit, the processing module 114 determines whether the enhanced total in-account limit is greater than the total contribution scale. If the enhanced total in-account limit of the member is not less than the total contribution scale, this means that there is a lower risk that the member might commit fraud. Then, a settlement-and-delivery procedure is carried out by the processing module 114 to directly calculate a winning amount of the member in this term according to the bidding amount and deliver the whole amount to the member. On the other hand, if the enhanced total in-account limit of the member enhanced by the credit enhancement information is still less than the total contribution scale, then a partial settlement procedure is carried out by the processing module 114 to calculate how much of the contribution amount that the member may receive. In the partial settlement procedure, an obtained amount to be actually obtained by the winning member is determined according to a difference between the enhanced total in-account limit and the total contribution scale. Here, the obtained amount is equal to a total winning amount with the difference amount deducted.

For example, if the Rosca group that the member joins has a total group term number of 37, the risk management term No. is the 20^{th} term and the member applies for bidding in the 18^{th} term, then the risk management module 113 determines that the current bidding term No. (the 18^{th} term) is less than the risk management term No. (the 20^{th} term). Accordingly, considering that the member has paid the periodic contribution amount of $10,000 for 18 terms and the second credit investigation information of the member has a credit limit of $150,000, the total in-account limit of the member in the current bidding term is (18−1)*$10,000+$150,000=$320,000. However, the total in-account limit ($320,000) is still less than the total contribution scale (37*$10,000=$370,000), so the member can choose to only receive a part of the winning amount or provide credit enhancement information with a credit limit of $50,000; in the latter case, the risk management module 113 will use the credit enhancement information to update the total in-account limit into an enhanced total in-account limit, i.e., $320,000+$50,000=$370,000. Thus, the enhanced total in-account limit ($370,000) becomes equal to the total contribution scale ($370,000), and then the processing module 114 carries out the settlement-and-delivery procedure so that the member can receive the winning amount according to the bidding amount. On the other hand, if the credit enhancement information provided by the member is still insufficient to make the enhanced total in-account limit equal to or greater than the total contribution scale or if the member fails to provide any credit enhancement information, the partial settlement procedure will be carried out by the processing module 114. In the partial settlement procedure, a difference amount ($50,000) between the total in-account limit ($320,000) and the total contribution scale ($370,000) is determined first. Here, assuming that according to the bidding amount ($1,000) of the member, the processing module 114 determines that the winning amount of the member in this term is $369,000, then an amount that the member can receive is equal to the winning amount ($369,000) minus the difference amount ($50,000), i.e., $369,000−$50,000=$319,000.

It shall be particularly noted that if the member has won a bid in an earlier term, this means that he will not be qualified to bid in subsequent terms. Furthermore, besides the current winning member, the Rosca group further includes in the current bidding term at least one previous winning client with the same Rosca condition and at least one non-winning client. The previous winning client has a bidding amount corresponding to a previous term in which he won a bid. More specifically, because the previous winning client has won a bid in a previous term, he needs to pay an actual paid amount in the current bidding term. In case an open Rosca system is adopted for the Rosca group, then the amount actually paid by the previous winning client is equal to the periodic contribution amount plus the bidding amount; in contrast, if a closed Rosca system is adopted for the Rosca group, then the amount actually paid by the previous winning client is just the periodic contribution amount. The non-winning client also needs to pay an actual paid amount in the current bidding term. In case an open Rosca system is adopted for the Rosca group, then the amount actually paid by the non-winning client is just the periodic contribution amount; in contrast, if a closed Rosca system is adopted for the Rosca group, then the amount actually paid by the non-winning client is equal to the periodic contribution amount minus the bidding amount of the member.

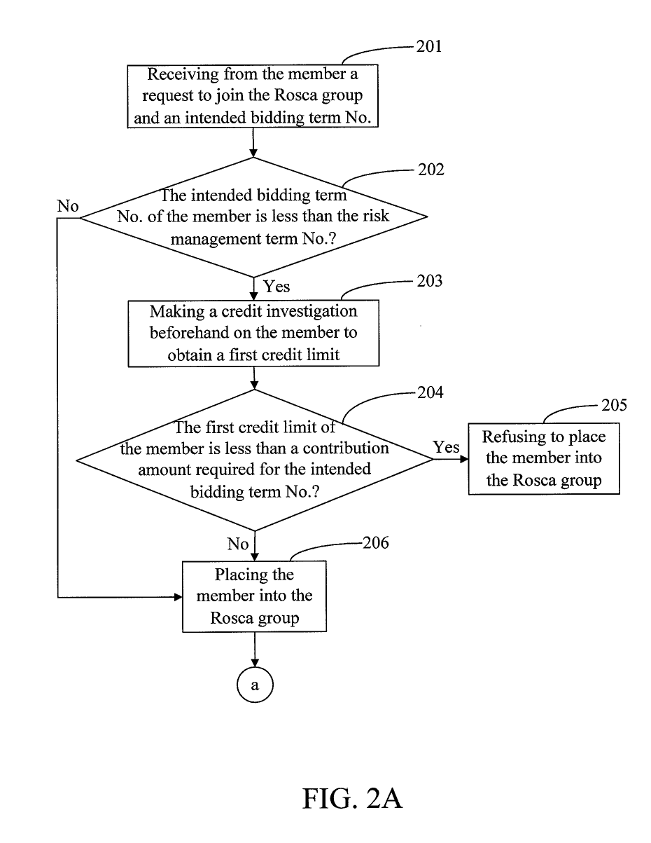

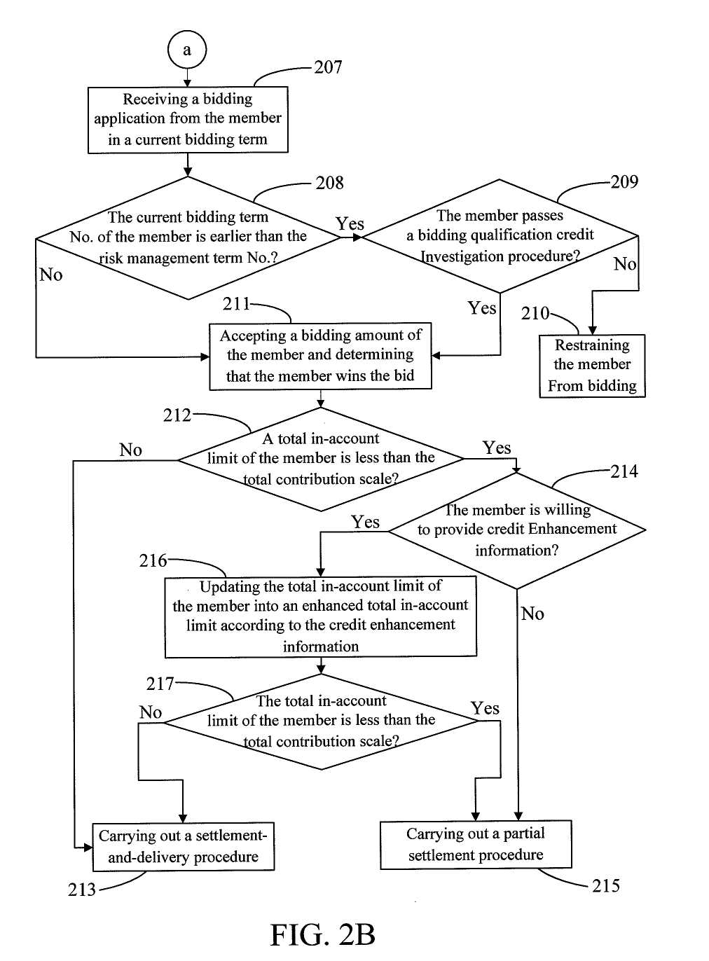

FIGS. 2A-2B illustrate flowcharts of the Rosca-risk management method of the present invention. The Rosca-risk management method is implemented by a processing apparatus, which may be the Rosca-risk management system 11 shown in FIG. 1. Likewise, the storage module 111 is configured to store a Rosca group, which records a Rosca condition and a risk tolerance level. The Rosca condition is configured to distinguish between different groups of a Rosca. Because different conditions may result in different groups of a Rosca, the Rosca condition comprises at least one of the following components: a Rosca group term No., a basic contribution amount, a Rosca period and a total Rosca contribution scale, to clearly distinguish between various Rosca groups of different conditions. The risk tolerance level is a market capital interest level. Furthermore, by using a client 12, a member can be connected with the receiving module 112 of the Rosca-risk management system 11 through a network to make a bid. The risk management module 113 is configured to determine a risk management term No. of the Rosca group according to the Rosca condition and the risk tolerance level of the Rosca group.

FIG. 2A illustrates a flowchart of placing members into a Rosca group. Step 201 is executed to enable the receiving module 112 of the Rosca-risk management system 11 to receive from the member a request to join the Rosca group and also an intended bidding term No. Then, step 202 is executed to enable the risk management module 113 of the Rosca-risk management system 11 to, by comparing the intended bidding term No. of the member with the risk management term No., determine whether to allow the member to join the Rosca group without performing a credit investigation step. If the intended bidding term No. of the member is set to be later than the risk management term No., this means that this member prefers to earn interests by depositing money. For such a member, there is a lower risk that he might commit fraud, so the member may join the Rosca group without performing the credit investigation step to prevent cumbersome credit investigation procedure. More specifically, if the risk management module 113 determines that the intended bidding term No. of the member is not less than the risk management term No., step 206 will directly be executed to enable the processing module 114 to, according to the intended bidding term No. of the member, place the member directly into the Rosca group to perform subsequent operations. Conversely, if the risk management module 113 determines that the intended bidding term No. of the member is less than the risk management term No., this means that there is a higher risk that the member might commit fraud, so a credit investigation on the member must be made beforehand.

Next, step 203 is executed to enable the processing module 114 to make a credit investigation on the member beforehand to obtain a first credit limit. The first credit limit may be determined according to at least one of the following criteria: an employment status, income, a credit status, assets and collateral information to confirm that the member, who presents a higher risk to commit fraud, has a sufficient ability to make the payment. Subsequently, step 204 is executed to enable the processing module 114 to determine whether the first credit limit of the member is less than a contribution amount required for the intended bidding term No. to assess a risk that the member might make a fraud. Here, the “contribution amount required for the intended bidding term No.” represents the concept that if the member bids in the intended bidding term, the contribution amount that he has paid in the preceding terms may also be used as a part of the credit.

If the processing module 114 determines that the first credit limit of the member is not less than the contribution amount required for the intended bidding term No., this means that the member has a high ability to pay a debt. Then, step 206 is executed to enable the processing module 114 to arrange the member directly into the Rosca group according to the intended bidding term No. of the member. Conversely, if the processing module 114 determines that the first credit limit of the member is less than the contribution amount required for the intended bidding term No., this means that there is still a higher risk that the member might commit fraud even after he has provided additional credit guarantee information. Then, step 205 is executed to refuse the placement of the member into the Rosca group.

It shall be particularly noted that the processing module 114 may further arrange the member into an appropriate Rosca group according to the intended bidding term No. of the member. More specifically, if clients with different intended bidding term Nos. are arranged into the same Rosca group, members with the same intended bidding term No. would not bid in the same term to allow for optimized rotating use of the Rosca funds.

Next, FIG. 2B illustrates a flowchart of bidding in the Rosca group. In other words, once the placement of members in the Rosca group is accomplished through the aforesaid steps, subsequent Rosca operations of the Rosca group can commence. Step 207 is executed to enable the receiving module 112 to receive a bidding application for a current bidding term from the member. Then, step 208 is executed to enable the risk management module 113 to determine whether the current bidding term No. of the member is earlier than the risk management term No. If yes, this means that there is a higher risk that the member might commit fraud, and step 209 is executed to enable the processing module 114 to carry out a bidding qualification credit investigation procedure on the member and determine whether the member passes the bidding qualification credit investigation procedure.

Furthermore, if the member fails to pass the bidding qualification credit investigation procedure, then step 210 is executed to restrain the member from bidding; in other words, if the member fails to pass the bidding qualification credit investigation procedure, this means that the member is still unable to bear a fraud risk, so the member is still denied to bid although he has been arranged into the Rosca group. Conversely, if the member passes the bidding qualification credit investigation procedure successfully, he will be allowed to bid. Subsequently, step 211 is executed to enable the receiving module 112 to accept a bidding amount of the member, and enable the processing module 114 to determine that the member has won the bid according to the bidding amount. Thereafter, step 212 is executed to determine whether a total in-account limit of the member is greater than the total contribution scale.

In step 212, the processing module 114 determines whether the total in-account limit of the member is greater than the total contribution scale, thereby deciding whether the winning member can receive the whole winning amount. In more detail, the total in-account limit of the member is equal to a second credit limit of the member plus a system natural limit. The second credit limit is determined according to at least one of the following criteria: an employment status, income, a credit status, assets and collateral information of the member. The system natural limit is equal to a creditor's-right amount of the member minus a debt amount of the member. More specifically, the creditor's-right amount refers to, among all Rosca groups that the member joins in a network Rosca organization to which the Rosca group belongs, an amount of creditor's rights of the member in all Rosca groups where he does not win a bid. The debt amount refers to, among all Rosca groups that the member joins in the network Rosca organization, an amount to be paid by the member in all Rosca groups where he wins a bid.

Hence, if the total in-account limit of the member is not less than the total contribution scale, this means that the member has adequate qualification to bid, and then step 213 is executed to carry out a settlement-and-delivery procedure. On the other hand, if the total in-account limit of the member is less than the total contribution scale, this means that there is a higher risk that the member might commit fraud, so step 214 is executed to enable the processing module 114 to determine whether the member is willing to provide credit enhancement information. If the member is unwilling to provide any credit enhancement information, this means that the member does not have an adequate ability to receive the whole winning amount, so step 215 is executed to carry out a partial settlement procedure. In the partial settlement procedure, an obtained amount to be actually obtained by the winning member is determined according to a difference between the enhanced total in-account limit and the total contribution scale. Here, the obtained amount is equal to a total winning amount with the difference amount deducted.

On the other hand, it is also possible that the member provides credit enhancement information as an attempt to withdraw the whole winning amount. In particular, if the member provides the credit enhancement information, step 216 is executed to update the total in-account limit of the member into an enhanced total in-account limit according to the credit enhancement information. Afterwards, step 217 is executed to determine whether the total in-account limit of the member is less than the total contribution scale. If not, this means that there is a lower risk that the member might commit fraud, and then step 213 is executed to carry out a settlement-and-delivery procedure directly; otherwise, if the determination result is yes, this means that the member does not have an adequate ability to receive the whole winning amount, and then step 215 is executed to carry out a partial settlement procedure.

It shall be further particularly noted that besides the current winning member, the Rosca group further includes in the current bidding term at least one previous winning member with the same Rosca condition and at least one non-winning member. The previous winning member has a bidding amount corresponding to a previous term in which he won a bid. More specifically, because the previous winning member has won a bid in a previous term, he needs to pay an actually paid amount in the current bidding term. In case an open Rosca system is adopted for the Rosca group, then the amount actually paid by the previous winning member is equal to the periodic contribution amount plus the bidding amount; in contrast, if a closed Rosca system is adopted for the Rosca group, then the amount actually paid by the previous winning member is just the periodic contribution amount. The non-winning member also needs to pay an actual paid amount in the current bidding term. In case an open Rosca system is adopted for the Rosca group, then the amount actually paid by the non-winning member is just the periodic contribution amount; in contrast, if a closed Rosca system is adopted for the Rosca group, then the amount actually paid by the non-winning member is equal to the periodic contribution amount minus the bidding amount of the member.

Hereinafter, an example will be described with reference to FIGS. 1-2B to explain how the present invention implements the Rosca-risk management.

### EXAMPLE

Ms. Qian, who is a retired public officer aged 60, actively looks for a way of financing while enjoying the leisured life after retirement. When she worked as a public officer, Ms. Qian had joined a Rosca to earn interests through money deposit as a way of building wealth. Meanwhile, Ms. Qian also took a measure of supporting contributions in one Rosca group with earnings from another Rosca group; i.e., she joined a Rosca which required a low bidding amount level to deposit money and tried to bid in the Rosca, and then used the bidding amount she obtained to join another Rosca that has a higher interest rate to obtain a higher deposit return. Such an operation mode of utilizing interest rate differences in different Roscas to make profits adopted by Ms. Qian is known in conventional Roscas as the “Saver-and-arbitrager strategy”. Recently, Ms. Qian learns that Bank SinoPac in Taiwan has provided an MMA Bidmoney Network product that promises a higher interest rate than time deposits and is free of fraud. So she attempts to learn about details of the product. Unfortunately, the MMA Bidmoney network requires making a credit investigation beforehand on each member and the fundamental of the credit investigation is based on the salary level, which considerably decreases the opportunity for Ms. Qian to join in the Rosca platform. So Ms. Qian feels puzzled: I am an arbitrager who just wants to earn money through deposit without presenting any risk, but why should I be subjected to so strict examination in this platform with so many inconveniences? Also at this time, Ms. Qian is informed that another bank, Qiaodu Bank, had provided an Rosca-risk management system 11 that also presents no risk fraud but requires no credit investigation beforehand. In this system, Ms. Qian who is a depositor can be allowed to join a Rosca group directly without being subjected to any credit investigation procedure; instead, a delayed or post examination can be made when Ms. Qian is to make a bid for arbitrage purpose, which remarkably increases the convenience and flexibility of participating in the Rosca platform.

First, Ms. Qian logs in the Rosca-risk management system 11 via a client 12. The storage module 111 of the Rosca-risk management system 11 stores a Rosca group which records an Rosca condition and a risk tolerance level. The Rosca condition has the following contents: a periodic contribution amount $10,000, a group term No. of 25 terms, and a total contribution scale of $240,000 ($10,000*(25−1)). Ms. Qian selects an intended bidding term No. to be the 25^{th} term, i.e., Ms. Qian wants to act as a depositor to earn interests. Then, according to the Rosca condition selected by Ms. Qian and a market capital interest level, a risk management term No. is calculated by the risk management module 113 to be the 15^{th} term. Hence, if the intended bidding term No. selected by Ms. Qian were the 15^{th} term or earlier than the 15^{th} term (step 202), then Ms. Qian would have to be subjected to a credit limit examination; however, Ms. Qian selects the intended bidding term No. to be the 25^{th} term which is later than the risk management term No. (the 15^{th} term), so the credit limit examination became unnecessary for her. Accordingly, Ms. Qian is arranged into the Rosca group directly by the processing module 114 (step 206). Information of the intended bidding term Nos. of individual members joining the same kind of Rosca groups in a specific period of time are placed in the Rosca groups by the processing module 114 in such a way that the intended bidding term Nos. of members in each Rosca group are distributed more evenly so that the members in the Rosca that Ms. Qian joins, including depositors and debtors, all have an opportunity to bid.

In the first several terms, Ms. Qian doesn't make a bid, so she only needs to pay the periodic contribution amount of $10,000 in each of the several terms. However, as the Rosca proceeds to the 16^{th} term, Ms. Qian is aware that the bidding interest of the Rosca group has become relatively low and there is another Rosca group with a higher bidding interest. Hence, Ms. Qian wants to apply for bidding (step 207) with the intention to earn money through interest arbitrage. The bidding application of Ms. Qian in the current bidding term is received by the receiving module 112, which then determines whether the current bidding term No. of Ms. Qian is greater than the risk management term No. Because the current bidding term No. (the 16^{th} term) is greater than the risk management term No. (the 15^{th} term), which means that there is a lower risk that Ms. Qian might commit fraud, Ms. Qian is allowed to bid directly. Subsequently, the receiving module 112 receives a bidding amount from Ms. Qian (step 211) and calculates a bidding result. It turns out that Ms. Qian wins the bid with a bidding amount of $600, and the winning amount is $234,600 ($10,000*15+($10,000−$600)*9).

Next, it is determined whether a total in-account limit of Ms. Qian is greater than the total contribution scale $240,000 (step 212). The total in-account limit of Ms. Qian is equal to a credit limit of Ms. Qiao plus a system natural limit. As currently Ms. Qian doesn't have any salary income, the credit investigation information of Ms. Qian only imparts her a credit limit of $50,000. The system natural limit refers to an accumulated deposit amount of Ms. Qian in all Rosca groups she has joined minus the total winning amount that she has won in all Rosca groups; since Ms. Qian has also joined another Rosca group of the same Rosca condition and the first two terms has completed in that Rosca group, and since 15 terms have been completed in the current Rosca group, the system natural limit of Ms. Qian is summed to be $170,000 ($20,000+$150,000). Hence, the total in-account limit of Ms. Qian is $220,000, i.e., the credit limit of $50,000 plus the system natural limit of $170,000.

Then, the processing module 114 determines that the total in-account limit $220,000 of Ms. Qian is less than the total contribution scale $240,000, so it further determines whether Ms. Qian is willing to provide credit enhancement information. If Ms. Qian provides credit enhancement information which has a credit limit of $20,000, then the processing module 114 updates the total in-account limit into an enhanced total in-account limit of $240,000 ($220,000+$20,000) and determines that the enhanced total in-account limit ($240,000) is not less than the total contribution scale ($240,000). Thus, Ms. Qian can now receive the whole winning amount ($234,600) (step 213). Conversely, if Ms. Qian is unwilling to provide additional asset, guarantor or collateral information, her total in-account limit become still less than the total contribution scale, in which case the processing module 114 performs a partial settlement procedure according to a difference amount of $20,000 ($220,000−$240,000) between the total in-account limit of $220,000 and the total contribution scale of $240,000. Thus, Ms. Qian can only receive a balance of deducting the difference amount $20,000 from the winning amount $234,600, i.e., $214,600 ($234,600−$20,000) (step 215).

According to the above descriptions, the Rosca-risk management method of the present invention has the following efficacies:

1. Because the present invention prevents the need of making a credit investigation on depositors and arbitragers who present no credit risks, it may effectively reduce the cost of credit investigations and reduce the operational cost of banks;

2. The present invention provides an objective credit assessment criteria, which assesses a credit level of a customer based on the credit created by the customer himself (i.e., the system natural limit) and is supplemented by the credit investigation system of banks to provide the customer with credit support required for additional financing;

3. By using the first and the second credit limits as a basis for assessing the credit risk of a customer, dependency of the banks on the conventional joint credit investigation system can be decreased, and the possibility that failure of the credit investigation system would cause a systematic credit risk on the platform may be prevented;

4. The possibility of mistakenly refusing a customer to join a Rosca group or making a wrong credit assessment is reduced, thereby enhancing both the willingness of the customer to participate and maintain market momentum;

5. The examination procedure involved when a customer participates in the platform is simplified, leading to a reduction in the waiting time of the customer; and

6. With the required credit level to participate being decreased, the customer base becomes more diversified to make the deposit to debt ratio closer to the market status. This makes the bidding amount closer to the market status and makes capital transaction more efficient.

According to the above descriptions, the present invention does provide an applicable Rosca-risk management system and a method thereof. As an inventive design that can reduce the cost of the system, increase the number of customers and promote the flow of capital, the Rosca-risk management system and the method thereof have improved industrial applicability. Therefore, the present invention is filed hereby for application in accordance with the Patent Law.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for risk management of an Rosca (Rotating Savings and Credit Association) group by use of a processing apparatus, the processing apparatus being connected with a client through a network, the method comprising the following steps of:
(A) enabling the processing apparatus to determine a risk management term No. of the Rosca group according to an Rosca condition and a risk tolerance level of the Rosca group, wherein the Rosca condition comprises at least one of the following components: an Rosca group term No., a basic contribution amount, an Rosca period and a total contribution scale;
(B) enabling the processing apparatus to determine whether a current bidding term No. of a member is earlier than the risk management term No. via the client; and
(C) enabling the processing apparatus to: if, according to the determination result of the step (B), the current bidding term No. is not earlier than the risk management term No., then allow the member to enter into a bidding procedure of the Rosca group via the client; or if the current bidding term No. is earlier than the risk management term No., then after determining that the member has passed a bidding qualification credit investigation procedure, allow the member to enter into the bidding procedure of the Rosca group via the client.

2. The method as claimed in claim 1, further comprising the following steps prior to the step (B):
(D) enabling the processing apparatus to receive an intended bidding term No. of the member from the client;
(E) enabling the processing apparatus to determine whether the intended bidding term No. of the member is earlier than the risk management term No.; and
(F) enabling the processing apparatus to: if, according to the determination result of the step (E), the intended bidding term No. of the member is earlier than the risk management term No., then according to a first credit limit of the member, determine that the first credit limit is not less than a contribution amount required for the intended bidding term No. and place the member into the Rosca group according to the intended bidding term No. of the member; or if the intended bidding term No. of the member is not earlier than the risk management term No., then place the member into the Rosca group according to the intended bidding term No. of the member;
wherein the first credit limit is determined according to at least one of the following criteria: an employment status, income, a credit status, assets and collateral information of the member.

3. The method as claimed in claim 2, further comprising the following steps after the step (C):
(G) enabling the processing apparatus to receive a bidding amount of the member from the client;
(H) enabling the processing apparatus to, according to the bidding amount, determine that the member wins the bid;
(I) enabling the processing apparatus to, after the step (H), determine that a total in-account limit of the member that wins the bid is not less than the total contribution scale, wherein the total in-account limit is equal to a second credit limit of the member plus a system natural limit, wherein the second credit limit is determined according to at least one of the following criteria: an employment status, income, a credit status, assets and collateral information of the member, the system natural limit is equal to a creditor's-right amount of the member minus a debt amount of the member, the creditor's-right amount refers to, among all Rosca groups that the member joins in a network Rosca organization to which the Rosca group belongs, an amount of creditor's rights of the member in all Rosca groups where the member does not win a bid, and the debt amount refers to, among all Rosca groups that the member joins in the network Rosca organization, an amount to be paid by the member in all Rosca groups where the member wins a bid; and
(J) enabling the processing apparatus to, according to the determination result of the step (I), carry out a settlement-and-delivery procedure.

4. The method as claimed in claim 2, further comprising the following steps after the step (C):
(G) enabling the processing apparatus to receive a bidding amount of the member from the client;
(H) enabling the processing apparatus to, according to the bidding amount, determine that the member wins the bid;
(I) enabling the processing apparatus to, after the step (H), determine that a total in-account limit of the member that wins the bid is less than the total contribution scale, wherein the total in-account limit is equal to a second credit limit of the member plus a system natural limit, wherein the second credit limit is determined according to at least one of the following criteria: an employment status, income, a credit status, assets and collateral information of the member, the system natural limit is equal to a creditor's-right amount of the member minus a debt amount of the member, the creditor's-right amount refers to, among all Rosca groups that the member joins in a network Rosca organization to which the Rosca group belongs, an amount of creditor's rights of the member in all Rosca groups where the member does not win a bid, and the debt amount refers to, among all Rosca groups that the member joins in the network Rosca organization, an amount to be paid by the member in all Rosca groups where the member wins a bid; and
(J) enabling the processing apparatus to, according to the determination result of the step (I), receive credit enhancement information of the member from the client and update the total in-account limit into an enhanced total in-account limit according to the credit enhancement information;
(K) enabling the processing apparatus to compare the enhanced total in-account limit with the total contribution scale; and
(L) enabling the processing apparatus to: if, according to the result of the step (K), it is determined that the enhanced total in-account limit is not less than the total contribution scale, then carry out a settlement-and-delivery procedure according to the result of the step (K), or, if it is determined that the enhanced total in-account limit is less than the total contribution scale, then carry out a partial settlement procedure according to the result of the step (K);
wherein the partial settlement procedure is to determine an obtained amount of the client that wins the bid according to a difference between the enhanced total in-account limit and the total contribution scale, and the obtained amount is equal to a total winning amount minus the difference amount.

5. An Rosca-risk management system, comprising:
a storage module, being configured to store an Rosca group which records an Rosca condition and a risk tolerance level, wherein the Rosca condition comprises at least one of the following components: an Rosca group term No., a basic contribution amount, an Rosca period and a total contribution scale;
a receiving module connected with a client through a network, being configured to receive a current bidding term No. of a member from the client;
a risk management module, being configured to determine a risk management term No. of the Rosca group according to the Rosca condition and the risk tolerance level of the Rosca group, and determine whether the current bidding term No. of the member is earlier than the risk management term No.; and
a processing module, being configured to: if, according to the determination result of the risk management module, the current bidding term No. is not earlier than the risk management term No., then allow the member to enter into a bidding procedure of the Rosca group via the client; or if the current bidding term No. is earlier than the risk management term No., then after determining that the member has passed a bidding qualification credit investigation procedure, allow the member to enter into the bidding procedure of the Rosca group via the client.

6. The Rosca-risk management system as claimed in claim 5, wherein before receiving the current bidding term No., the receiving module receives an intended bidding term No. of the member from the client, and then the risk management module determines whether the intended bidding term No. is earlier than the risk management term No., wherein if the intended bidding term No. of the member is earlier than the risk management term No., then the processing module determines, according to a first credit limit of the member, that the first credit limit is not less than a contribution amount required for the intended bidding term No. and place the member into the Rosca group according to the intended bidding term No. of the member; or, if the intended bidding term No. of the member is not earlier than the risk management term No., then the processing module places the member into the Rosca group according to the intended bidding term No. of the member, and wherein the first credit limit is determined according to at least one of an employment status, income, a credit status, assets and collateral information of the member.

7. The Rosca-risk management system as claimed in claim 6, wherein after the processing module allows the member to enter into the bidding procedure, the receiving module receives a bidding amount of the member from the client, and the processing module determines, according to the bidding amount, that the member wins the bid, determines that a total in-account limit of the member that wins the bid is not less than the total contribution scale and then carries out a settlement-and-delivery procedure, wherein the total in-account limit is equal to a second credit limit of the member plus a system natural limit, wherein the second credit limit is determined according to at least one of the following criteria: an employment status, income, a credit status, assets and collateral information of the member, the system natural limit is equal to a creditor's-right amount of the member minus a debt amount of the member, the creditor's-right amount refers to, among all Rosca groups that the member joins in a network Rosca organization to which the Rosca group belongs, an amount of creditor's rights of the member in all Rosca groups where the member does not win a bid, and the debt amount refers to, among all Rosca groups that the member joins in the network Rosca organization, an amount to be paid by the member in all Rosca groups where the member wins a bid.

8. The Rosca-risk management system as claimed in claim 6, wherein after the processing module allows the member to enter into the bidding procedure, the receiving module receives a bidding amount of the member from the client, the processing module determines that the member wins the bid according to the bidding amount and then determines that a total in-account limit of the member that wins the bid is less than the total contribution scale, then the receiving module receives credit enhancement information of the member from the client, and the processing module updates the total in-account limit into an enhanced total in-account limit according to the credit enhancement information and compares the enhanced total in-account limit with the total contribution scale, wherein if the enhanced total in-account limit is not less than the total contribution scale, then the processing module carries out a settlement-and-delivery procedure, or, if the enhanced total in-account limit is less than the total contribution scale, then the processing module carries out a partial settlement procedure, wherein the partial settlement procedure is to determine an obtained amount of the client that wins the bid according to a difference between the enhanced total in-account limit and the total contribution scale, and the obtained amount is equal to a total winning amount minus the difference amount, the total in-account limit is equal to a second credit limit of the member plus a system natural limit, wherein the second credit limit is determined according to at least one of the following criteria: an employment status, income, a credit status, assets and collateral information of the member, the system natural limit is equal to a creditor's-right amount of the member minus a debt amount of the member, the creditor's-right amount refers to, among all Rosca groups that the member joins in a network Rosca organization to which the Rosca group belongs, an amount of creditor's rights of the member in all Rosca groups where the member does not win a bid, and the debt amount refers to, among all Rosca groups that the member joins in the network Rosca organization, an amount to be paid by the member in all Rosca groups where the member wins a bid.

9. A method for risk management of an Rosca group by use of a processing apparatus, the processing apparatus being connected with a client through a network, the method comprising the following steps of:
(A) enabling the processing apparatus to determine a risk management term No. of the Rosca group according to an Rosca condition and a risk tolerance level of the Rosca group, wherein the Rosca condition comprises at least one of the following components: an Rosca group term No., a basic contribution amount, an Rosca period and a total contribution scale;
(B) enabling the processing apparatus to determine whether an intended bidding term No. of a member is earlier than the risk management term No.; and
(C) enabling the processing apparatus to: if, according to the determination result of the step (B), the intended bidding term No. of the member is earlier than the risk management term No., then according to a first credit limit of the member, determine that the first credit limit is not less than a contribution amount required for the intended bidding term No. and place the member into the Rosca group according to the intended bidding term No. of the member; or if the intended bidding term No. of the member is not earlier than the risk management term No., then place the member into the Rosca group according to the intended bidding term No. of the member,
wherein the first credit limit is determined according to at least one of the following criteria: an employment status, income, a credit status, assets and collateral information of the member.

10. The method as claimed in claim 9, further comprising the following steps after the step (D):
(E) enabling the processing apparatus to determine whether a current bidding term No. of the member is earlier than the risk management term No. via the client; and
(F) enabling the processing apparatus to: if, according to the determination result of the step (E), the current bidding term No. is not earlier than the risk management term No., then allow the member to enter into a bidding procedure of the Rosca group via the client; or, if the current bidding term No. is earlier than the risk management term No., then after determining that the member has passed a bidding qualification credit investigation procedure, allow the member to enter into the bidding procedure of the Rosca group via the client.

11. The method as claimed in claim 10, further comprising the following steps after the step (F):
(G) enabling the processing apparatus to receive a bidding amount of the member from the client;
(H) enabling the processing apparatus to, according to the bidding amount, determine that the member wins the bid;
(I) enabling the processing apparatus to, after the step (H), determine that a total in-account limit of the member that wins the bid is not less than the total contribution scale, wherein the total in-account limit is equal to a second credit limit of the member plus a system natural limit, wherein the second credit limit is determined according to at least one of the following criteria: an employment status, income, a credit status, assets and collateral information of the member, the system natural limit is equal to a creditor's-right amount of the member minus a debt amount of the member, the creditor's-right amount refers to, among all Rosca groups that the member joins in a network Rosca organization to which the Rosca group belongs, an amount of creditor's rights of the member in all Rosca groups where the member does not win a bid, and the debt amount refers to, among all Rosca groups that the member joins in the network Rosca organization, an amount to be paid by the member in all Rosca groups where the member wins a bid; and
(J) enabling the processing apparatus to, according to the determination result of the step (I), carry out a settlement-and-delivery procedure.

12. The method as claimed in claim 10, further comprising the following steps after the step (F):
(G) enabling the processing apparatus to receive a bidding amount of the member from the client;
(H) enabling the processing apparatus to, according to the bidding amount, determine that the member wins the bid;
(I) enabling the processing apparatus to, after the step (H), determine that a total in-account limit of the member that wins the bid is less than the total contribution scale, wherein the total in-account limit is equal to a second credit limit of the member plus a system natural limit, wherein the second credit limit is determined according to at least one of the following criteria: an employment status, income, a credit status, assets and collateral information of the member, the system natural limit is equal to a creditor's-right amount of the member minus a debt amount of the member, the creditor's-right amount refers to, among all Rosca groups that the member joins in a network Rosca organization to which the Rosca group belongs, an amount of creditor's rights of the member in all Rosca groups where the member does not win a bid, and the debt amount refers to, among all Rosca groups that the member joins in the network Rosca organization, an amount to be paid by the member in all Rosca groups where the member wins a bid; and
(J) enabling the processing apparatus to, according to the determination result of the step (I), receive credit enhancement information of the member from the client and update the total in-account limit into an enhanced total in-account limit according to the credit enhancement information;
(K) enabling the processing apparatus to compare the enhanced total in-account limit with the total contribution scale; and
(L) enabling the processing apparatus to: if, according to the result of the step (K), it is determined that the enhanced total in-account limit is not less than the total contribution scale, then carry out a settlement-and-delivery procedure according to the result of the step (K); or, if it is determined that the enhanced total in-account limit is less than the total contribution scale, then carry out a partial settlement procedure according to the result of the step (K);
wherein the partial settlement procedure is to determine an obtained amount of the client that wins the bid according to a difference between the enhanced total in-account limit and the total contribution scale, and the obtained amount is equal to a total winning amount minus the difference amount.

13. An Rosca-risk management system, comprising:
a storage module, being configured to store an Rosca group which records an Rosca condition and a risk tolerance level, wherein the Rosca condition comprises at least one of the following components: an Rosca group term No., a basic contribution amount, an Rosca period and a total contribution scale;
a receiving module connected with a client through a network, being configured to receive an intended bidding term No. of a member from the client;
a risk management module, being configured to determine a risk management term No. according to the Rosca condition and the risk tolerance level of the Rosca group, and determine whether the intended bidding term No. of the member is earlier than the risk management term No.; and
a processing module, being configured to: if, according to the determination result of the risk management module, the intended bidding term No. of the member is earlier than the risk management term No., then according to a first credit limit of the member, determine that the first credit limit is not less than a contribution amount required for the intended bidding term No. and place the member into the Rosca group according to the intended bidding term No. of the member; or if the intended bidding term No. of the member is not earlier than the risk management term No., then place the member into the Rosca group according to the intended bidding term No. of the member;
wherein the first credit limit is determined according to at least one of the following criteria: an employment status, income, a credit status, assets and collateral information of the member.

14. The Rosca-risk management system as claimed in claim 13, wherein after the processing module places the member into the Rosca group, the receiving module receives a current bidding term No. of the member from the client, the risk management module determines whether the current bidding term No. of the member is earlier than the risk management term No., and wherein if the current bidding term No. is not earlier than the risk management term No., then the processing module allows the member to enter into a bidding procedure of the Rosca group via the client; or if the current bidding term No. is earlier than the risk management term No., then after determining that the member has passed a bidding qualification credit investigation procedure, the processing module allows the member to enter into the bidding procedure of the Rosca group via the client.

15. The Rosca-risk management system as claimed in claim 14, wherein after the processing module allows the member to enter into the bidding procedure, the receiving module receives a bidding amount of the member from the client, and the processing module determines, according to the bidding amount, that the member wins the bid, determines that a total in-account limit of the member that wins the bid is not less than the total contribution scale and then carries out a settlement-and-delivery procedure, wherein the total in-account limit is equal to a second credit limit of the member plus a system natural limit, wherein the second credit limit is determined according to at least one of the following criteria: an employment status, income, a credit status, assets and collateral information of the member, the system natural limit is equal to a creditor's-right amount of the member minus a debt amount of the member, the creditor's-right amount refers to, among all Rosca groups that the member joins in a network Rosca organization to which the Rosca group belongs, an amount of creditor's rights of the member in all Rosca groups where the member does not win a bid, and the debt amount refers to, among all Rosca groups that the member joins in the network Rosca organization, an amount to be paid by the member in all Rosca groups where the member wins a bid.

16. The Rosca-risk management system as claimed in claim 14, wherein after the processing module allows the member to enter into the bidding procedure, the receiving module receives a bidding amount of the member from the client, the processing module determines that the member wins the bid according to the bidding amount and then determines that a total in-account limit of the member that wins the bid is less than the total contribution scale, then the receiving module receives credit enhancement information of the member from the client, and the processing module updates the total in-account limit into an enhanced total in-account limit according to the credit enhancement information and compares the enhanced total in-account limit with the total contribution scale, wherein if the enhanced total in-account limit is not less than the total contribution scale, then the processing module carries out a settlement-and-delivery procedure, or, if the enhanced total in-account limit is less than the total contribution scale, then the processing module carries out a partial settlement procedure, wherein the partial settlement procedure is to determine an obtained amount of the client that wins the bid according to a difference between the enhanced total in-account limit and the total contribution scale, and the obtained amount is equal to a total winning amount minus the difference amount, the total in-account limit is equal to a second credit limit of the member plus a system natural limit, wherein the second credit limit is determined according to at least one of the following criteria: an employment status, income, a credit status, assets and collateral information of the member, the system natural limit is equal to a creditor's-right amount of the member minus a debt amount of the member, the creditor's-right amount refers to, among all Rosca groups that the member joins in a network Rosca organization to which the Rosca group belongs, an amount of creditor's rights of the member in all Rosca groups where the member does not win a bid, and the debt amount refers to, among all Rosca groups that the member joins in the network Rosca organization, an amount to be paid by the member in all Rosca groups where the member wins a bid.
